(19) United States
(12) Patent Application Publication
(10) Pub. No.: US 2025/0340203 A1
(43) Pub. Date: Nov. 6, 2025

(54) VEHICLE SUNROOF OCCUPANT DETECTION AND MITIGATION SYSTEM

(71) Applicant: Magna Electronics Inc., Auburn Hills, MI (US)

(72) Inventors: Ramallingeswara Rao P., Andhra Pradesh (IN); Shrestha Priya, Bihar (IN); Ramnath Baje Shenoy, Karnataka State (IN); Krishnanand Hindoddi, Karnataka (IN)

(21) Appl. No.: 19/194,107

(22) Filed: Apr. 30, 2025

Related U.S. Application Data
(60) Provisional application No. 63/640,910, filed on May 1, 2024.

(51) Int. Cl. B60W 30/09; B60W 50/14; G07C 5/08

(52) U.S. Cl. CPC B60W 30/09; B60W 50/14; G07C 5/0825; G07C 5/0833; B60W 2050/143; B60W 2420/403; B60W 2420/408; B60W 2520/10; B60W 2540/18; B60W 2554/20; B60W 2556/35; B60W 2710/18; B60W 2710/20

(57) ABSTRACT

A vehicular sunroof system includes a sensor disposed at a vehicle and sensing at least a sunroof at a roof of the vehicle. The sensor is operable to capture sensor data. An electronic control unit (ECU) includes electronic circuitry and associated software. The electronic circuitry includes a processor for processing sensor data captured by the sensor. The vehicular sunroof system, via processing by the processor of sensor data captured by the sensor, determines presence of an object at the sunroof opening. Responsive to (i) the vehicle moving and (ii) the sunroof being in an opened position, the system is operable to determine presence of an object at the sunroof opening. With the vehicle moving and with the sunroof being in the opened position, and responsive to determination of presence of the object at the sunroof opening, the system generates an alert and/or controls steering and/or braking of the vehicle.

### CROSS REFERENCE TO RELATED APPLICATION

The present application claims the filing benefits of U.S. provisional application Ser. No. 63/640,910, filed May 1, 2024, which is hereby incorporated herein by reference in its entirety.

### FIELD OF THE INVENTION

The present invention relates generally to a vehicle sensing system for a vehicle and, more particularly, to a vehicle sensing system that utilizes one or more interior-sensing sensors and/or one or more exterior sensing sensors at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties. Furthermore, use of radar sensors in vehicle sensing systems is common and known. Examples of such known systems are described in U.S. Pat. Nos. 9,146,898; 8,027,029 and/or 8,013,780, which are hereby incorporated herein by reference in their entireties.

### SUMMARY OF THE INVENTION

A vehicular sensing system or driving assistance system or vision system or imaging system or alert system for a vehicle utilizes one or more sensors to sense within an interior cabin of the vehicle and optionally to sense forward or rearward of the vehicle. The vehicular sensing system may work in conjunction with operation of a vehicle sunroof system of the vehicle.

For example, a vehicular sunroof system may include a sensor disposed at a vehicle equipped with the vehicular sunroof system, where the sensor senses at least a sunroof disposed at a roof of the vehicle. The sensor is operable to capture sensor data. The sunroof is moveable between an opened position and a closed position. When the sunroof is in a closed position, the sunroof passageway is blocked by the sunroof and the roof of the vehicle is closed or sealed, whereas the sunroof passageway is unobstructed when the sunroof is in an opened position. An electronic control unit (ECU) includes electronic circuitry and associated software. The electronic circuitry of the ECU includes at least one data processor for processing sensor data captured by the sensor and transferred to the ECU. The vehicular sunroof system determines, via processing of sensor data captured by the sensor, the presence of an object (e.g., an occupant) extending through a sunroof passageway or opening at a roof of the vehicle.

Responsive to (i) the vehicle moving and (ii) the sunroof being in the opened position, the vehicular sunroof system, via processing at the ECU of sensor data captured by the sensor, is operable to determine presence of an object at the sunroof opening. With the vehicle moving and with the sunroof being in the opened position, and responsive to determination, via processing at the ECU of sensor data captured by the sensor, of presence of the object at the sunroof opening, the vehicular sunroof system at least one selected from the group consisting of (a) generates an alert and (b) controls at least one selected from the group consisting of steering of the vehicle and braking of the vehicle. The alert may include, depending on configurable vehicle settings, audible alerts or warnings and/or alerts or visual warnings and/or haptic alerts or warnings. The system may control steering and/or braking of the vehicle to mitigate the safety risks associated with an object or occupant extending through the sunroof passageway.

These and other objects, advantages, purposes and features of the present invention will become apparent upon review of the following specification in conjunction with the drawings.

### BRIEF DESCRIPTION OF THE DRAWINGS

FIG. 1 is a side-view of a vehicle equipped with a sunroof sensing system, shown with the sunroof in a closed position;

FIG. 2 is an enlarged side-view of the vehicle of FIG. 1, shown with the sunroof in an opened position;

FIG. 3 is a perspective view of an interior cabin of the vehicle;

FIG. 4 is a warning symbol associated with the sunroof sensing system;

FIG. 5 is another warning symbol associated with the sunroof sensing system; and

FIG. 6 is a flowchart showing the function and operation of the sunroof sensing system within the vehicle.

### DESCRIPTION OF THE PREFERRED EMBODIMENTS

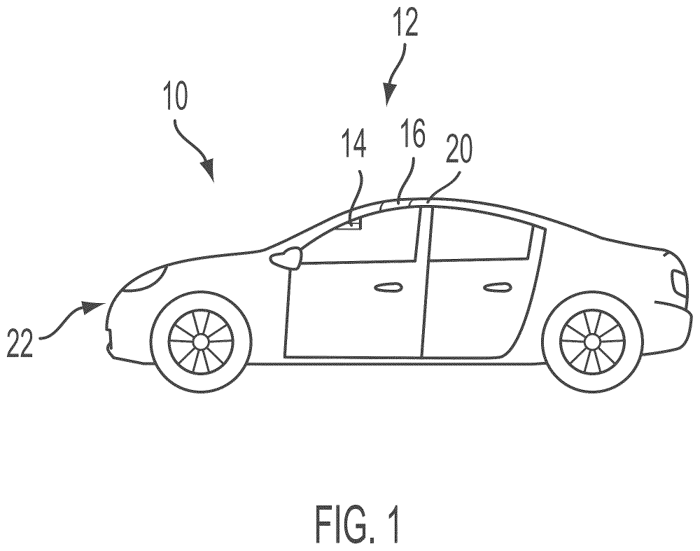

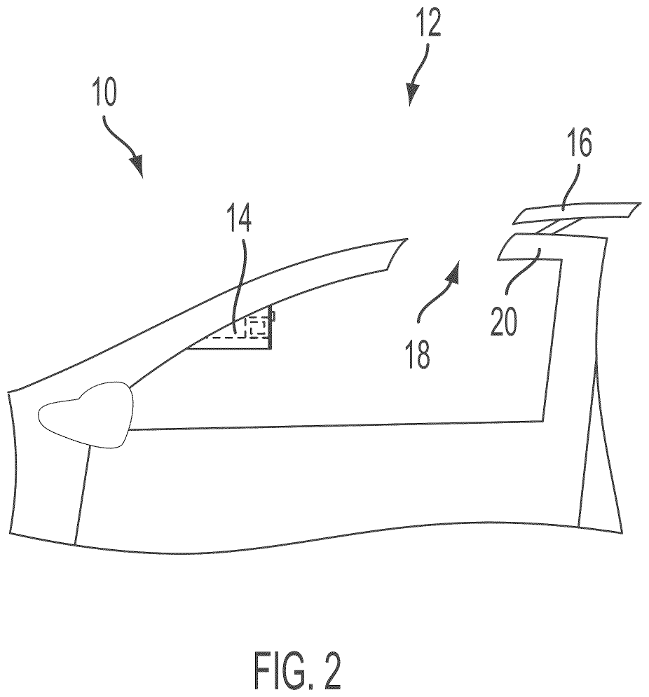

Referring now to the drawings and the illustrative embodiments depicted therein, a vehicle sunroof sensing system 10 for a vehicle 12 includes at least one interior sensor or sensor 14 positioned to sense at least a sunroof 16 and the scene occurring at a or near a sunroof opening or passageway 18 of the vehicle 12 (FIGS. 1 and 2). The sunroof 16 is disposed at a roof 20 of the vehicle 12 and is adjustable or movable between a closed position, where the sunroof 16 seals and blocks the sunroof opening 18 (as seen in FIG. 1), and an open position, where the sunroof 16 is at least partially moved from and is not present at the sunroof opening 18 and the sunroof opening 18 is unobstructed and open (as seen in FIG. 2). During operation of the system 10, the system 10 determines if an object or occupant is present in the sunroof opening 18 via processing of an output of the sensor 14. If the system determines that an object or occupant is present in the sunroof opening 18, the system 10 either generates an alert to the driver of the vehicle 12, takes over control of certain vehicle operations, or both generates an alert and takes over control of certain vehicle operations. The system 10 may operate when the vehicle 12 is in an “on” or “ignition-on” state, and when the vehicle 12 is moving, and when the sunroof 16 is in the open position. If the sunroof 16 is in the closed position, or if the vehicle 12 is not in the on or ignition-on state, or if the vehicle is stationary, the system 10 may not operate to determine if an object or occupant is present at the sunroof 16.

The system 10 includes a control or electronic control unit (ECU) having electronic circuitry and associated software, with the electronic circuitry including a data processor and/or an image processor that is operable to process image data and sensor data captured by the sensor 14, whereby the ECU may detect or determine presence of objects or occupants or the like and/or the system provide displayed images at a display device for viewing by the driver of the vehicle 12. The data transfer or signal communication from the sensor 14 to the ECU may comprise any suitable data or communication link, such as a vehicle network bus or the like of the vehicle 12. The sensor 14 that senses the scene at the sunroof opening 18 may include one or more sensors, such as a camera and/or a radar sensor and/or a lidar sensor and/or a time-of-flight (TOF) sensor and/or an ultrasonic sensor.

In one example, a driver monitoring camera (such as disposed at a mirror head of an interior rearview mirror assembly) views within an interior cabin of the vehicle 12 (including the driver head region within the interior cabin) and views at or immediately below the sunroof opening 18, and the system 10 determines presence of an object or occupant at the sunroof opening 18 via processing of image data captured by the driver monitoring camera. Image data captured by the driver monitoring camera is processed to monitor the driver, such as to determine driver attentiveness or driver drowsiness or driver gaze direction and the like. Image data captured at an upper region of the field of view of the driver monitoring camera (the region that includes the sunroof opening 18 or that is immediately below the sunroof opening 18) may be processed at the ECU to determine presence of an object or occupant at the headliner and sunroof opening 18. In other words, portions of image data captured by the driver monitoring camera may be processed to monitor the driver, while other portions of the image data captured by the driver monitoring camera may be processed for the sunroof system 10.

When the system 10 is operational, image data or sensor data captured by the sensor 14 is transferred to and processed at the ECU of the vehicle 12, and the system 10 determines if an object or occupant is present in the sunroof opening 18. Responsive to determining presence of an object or occupant in the sunroof opening 18, based on the image or sensor data received from the sensor 14 and processed by the ECU, the system 10 provides a resulting vehicle action. As described above, the resulting vehicle action may be providing an alert to the driver, taking over control of certain vehicle operations such as, for example, steering and braking, or a combination of both providing an alert and taking over control of certain vehicle operations.

In an effort to mitigate the risks associated with an object or occupant extending through the sunroof opening 18, the system 10 may control one or more systems or accessories of the vehicle 12 to perform various actions based on both the data received by the ECU and the vehicle settings configured by the driver. These actions may vary based on a plurality of factors, such as the data received by and processed at the ECU, the vehicle settings, and the type of vehicle in which the system 10 is included. The system 10 may provide the driver with multiple options that can be selected based on the driver's preferences. One option may be to enable or disable the system 10 completely. If the system 10 is enabled, it will allow the ECU to control the vehicle 12 to perform various actions based on the received data when the vehicle 12 is in the ignition-on state, the vehicle 12 is moving, and the sunroof 16 is in the open position. If the system 10 is disabled, the ECU will not control the vehicle 12 to perform any actions related to the system 10. There may be scenarios, however, where the system 10 cannot be disabled by the driver, depending on the specific application.

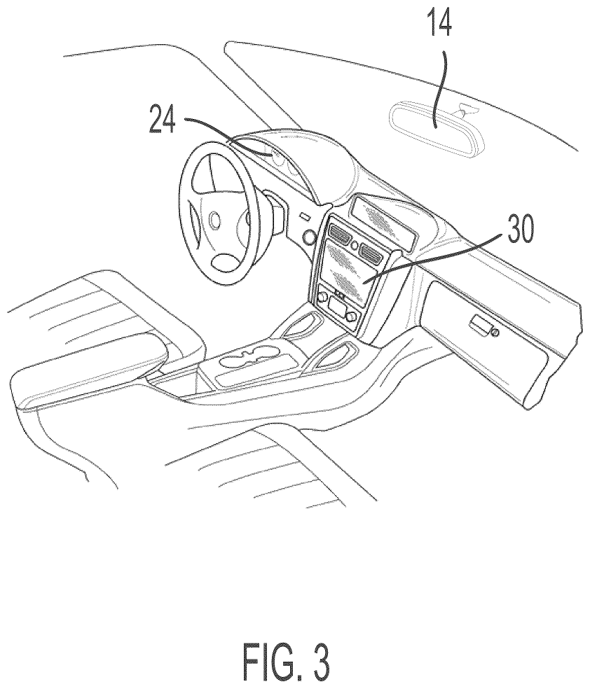

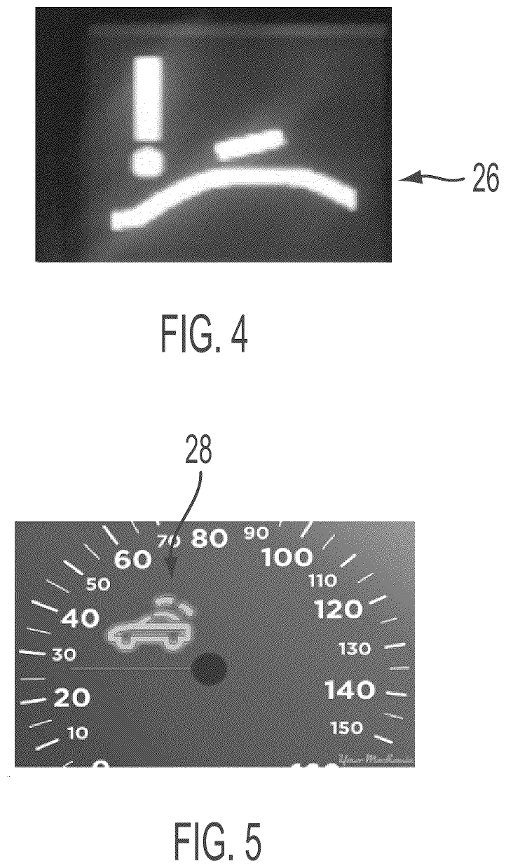

Optionally, the system may be operable in a “mitigate and alert” mode, or an “alert only” mode. With reference to FIGS. 3-5, the ECU may control an alert system of the vehicle 12 to provide audio and/or visual and/or haptic alerts or warnings based on the received data when the system is operating in the “alert only” mode, thereby informing the driver on a screen, such as an instrument cluster 24, that an occupant or object is present in the sunroof opening 18. The visual warning may comprise a warning indicator or symbol 26, 28, associated with an object or occupant present in the sunroof opening 18. Alternatively, the system may control one or more systems or accessories of the vehicle to provide audio and/or visual and/or haptic warnings as well as alter vehicle operations, such as acceleration, braking, or steering, in an effort to mitigate the risks associated with the present scenario when the system 10 is operating in the “mitigate and alert” mode and when an object or occupant is detected in the sunroof opening 18. The mitigation procedures may vary based on the received data by the ECU. The system may operate in either the “alert only” mode or the “mitigate and alert” mode depending on the particular application of the system. Alternatively, the driver or occupant of the vehicle may select either mode for operation, such as via actuation of a user input of the system 10.

Optionally, the system 10 may include one or multiple exterior or forward-sensing sensors 22 disposed at the vehicle 12. The forward-sensing sensor 22 may be a camera or a radar sensor or a lidar sensor or a TOF sensor or an ultrasonic sensor at a front of the vehicle 12. Sensor data captured by the forward-sensing sensor 22 is processed at the ECU to determine and/or analyze road conditions forward of the vehicle 12. Road conditions may include, but are not limited to, other vehicles on the road, the general condition of the road, objects or obstacles present on the road, the configuration or route or curvature of the road, weather conditions, etc. Furthermore, the system 10 may utilize map data 30, such as data provided by a global positioning system (GPS) of the vehicle 12, to provide additional information and data to the ECU related to the road along which the vehicle 12 is traveling. Additionally, the ECU may analyze vehicle operation data, which may include, but is not limited to, vehicle speed, acceleration, and steering (e.g. steering angle of a steering wheel of the vehicle 12), when determining the level of danger associated with an object or occupant present in the sunroof opening 18, which, as a result, may affect the mitigation procedures of the vehicle 12.

When the captured sensor data and/or map data and/or other information or data pertaining to the road or driving conditions are processed at the ECU, the system 10 determines both the presence of an object or occupant within the sunroof opening 18, as well as the amount of risk associated with the object or occupant within the sunroof opening 18 based on the received data, including data received by the sensor 14, the forward-sensing sensor 22, and vehicle operation data. As an example, the amount of risk associated with an occupant present in the sunroof opening 18 when the vehicle 12 is traveling at a high rate of speed may be much higher than the amount of risk associated with an occupant present in the sunroof opening 18 when the vehicle 12 is traveling at an extremely slow speed.

Thus, if the system 10 is enabled and operating in the “mitigate and alert” mode, with the sunroof 16 is in the open position, and with an occupant standing or reaching or extending through the sunroof opening 18 when the vehicle 12 is traveling at a high rate of speed and/or is traveling along a road that has many curves and turns, the system 10 may determine that the level of danger is high (greater than a threshold level). As a result, the system 10 will alert the driver that an occupant is standing through the sunroof opening 18 via audio and/or visual and/or haptic indications, as well as alter the vehicle operations, such as by controlling the acceleration or deceleration (e.g., controlling braking) of the vehicle 12 to slow down the vehicle 12. If the system 10 determines that the level of danger is below the threshold value but still above a lower threshold (e.g., the system determines that the vehicle 12 is traveling along a straight road or at a lower speed or the like), the system 10 may only provide the alert to the driver or may control the vehicle 12 at a lower level of control. Thus, the system may adjust the level of control and/or the alert based in part on the level of danger of the current driving condition.

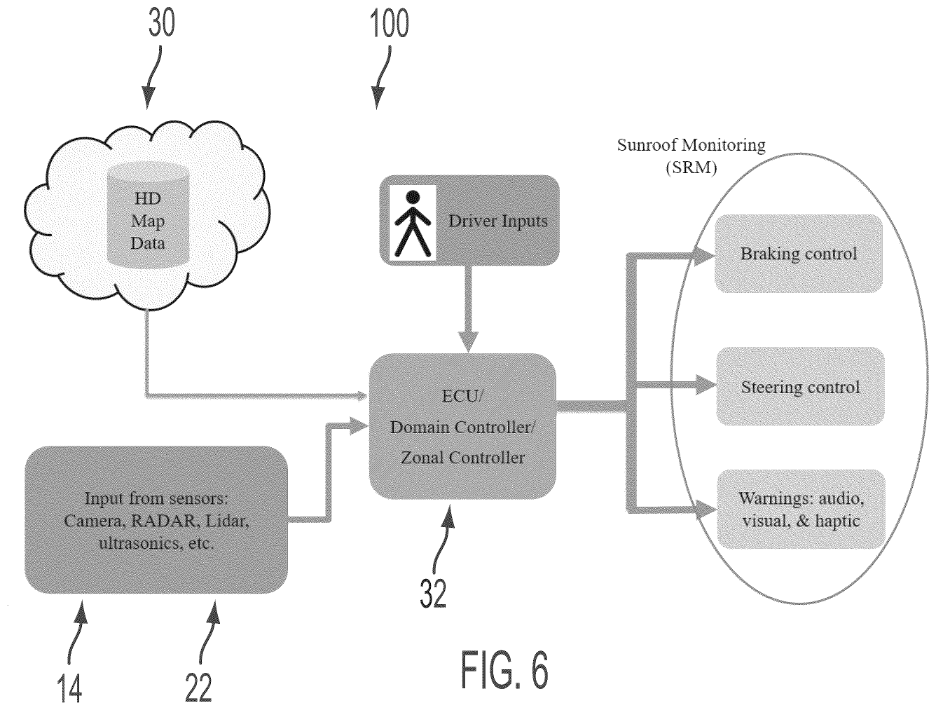

With reference to FIG. 6, a flowchart 100 shows the function and operation of the system 10. Map data 30 and data captured by the sensor 14 that senses the sunroof opening and data captured by the forward-sensing sensor or sensors 22 are transferred to an ECU 32 of the vehicle 12. The ECU 32 processes the data to determine the level of danger for a specific situation, as well as the resulting actions that are necessary to safely mitigate the risk or alert the driver of the risk. The system 10 is also responsive to driver inputs, such as whether the driver selected the “mitigate and alert” mode or the “alert only” mode, as well as the steering, braking, acceleration, and/or other vehicle actions performed by the driver. As a result, the system 10 controls one or more systems or accessories of the vehicle 12 to take over control of certain vehicle operations, such as braking and steering, and/or to provide audio, visual, and/or haptic alerts or warnings.

While the interior sensor 14 and forward-sensing sensor 22 are used for the system 10, the sensor 14 and forward-sensing sensor 22 may capture sensor data for use with other advanced driver assistance systems (ADAS) included in the vehicle 12.

Fusion of the captured image data and the captured sensor data and/or processing of the image data and sensor data in a cooperative manner by the ECU may utilize characteristics of the systems described in U.S. Pat. Nos. 9,495,876; 9,126,525 and/or 9,036,026, which are hereby incorporated herein by reference in their entireties.

Squeezing oneself out of the sunroof of the vehicle while in motion poses a serious threat to one's life. An emergency braking maneuver by the driver can throw the person looking out of the sunroof out of the vehicle. The forces generated during hard braking are very high, and during an emergency braking maneuver, even a parent holding a child tightly when the child looks out of the sunroof may not to be able to secure the child. Furthermore, accidents can cause the person looking out of the sunroof to be thrown out of the vehicle. Roll-over accidents may increase the amount of danger to the person extending out of the sunroof, as the person may ultimately be crushed during the roll-over. Debris thrown from the road may also hit the person in the face or eye, resulting in severe injuries. Aside from persons reaching or extending out of the sunroof, placing long, heavy, or breakable objects in the sunroof opening also poses a threat to passengers in the vehicle as well as to others on the road.

Current ADAS systems in vehicles lack a mechanism to caution or alert the driver of the vehicle by identifying potentially dangerous situations in which the sunroof is in the opened position and the sunroof opening is occupied. The risks of this scenario may still be minimal at lower speeds, but they will significantly increase when the vehicle is moving quickly. The sunroof sensing system is configured to detect the presence of an object in the sunroof opening and take necessary actions, via warning and mitigation, based on the vehicle operation data and environmental inputs obtained from the sensors and maps.

The system gathers information from one or more sensors, map data, and vehicle operation data. The data is then processed at the ECU to ascertain the condition of an object or occupant presence in the sunroof opening. Under this condition, based on the speed of the vehicle being greater than a threshold speed and the road conditions forward of the vehicle (e.g. curved road, tunnel, low barricade, potholes, low entrance parking, objects or obstacles, etc., some conditions of which may be tuned per the preferences of the driver) the system (or other forward-sensing system of the vehicle) may determine the presence of a hazardous condition and the sunroof system may alert the driver of the impending danger or may control the vehicle to reduce or mitigate the risk. In some examples, the system may determine whether a detected object ahead of the vehicle (e.g., an overhanging branch, low tunnel, etc.) is at a location where the object determined to be present at the sunroof opening may impact the detected object ahead of the vehicle.

The system may use inputs from one or multiple sensors installed at the vehicle (the sensors of which may comprise one or more of (i) an image sensor or camera, (ii) a radar sensor, and (iii) a lidar sensor), together with the inputs from HD maps in order to determine the road conditions and/or environmental conditions forward of the vehicle. The system also uses one or more sensors for object detection in the sunroof opening (e.g., the sensors of which may comprise one or more of (i) an image sensor or camera, (ii) a radar sensor, and (iii) a lidar sensor). The system first detects whether the sunroof is in the opened position before determining whether the sunroof opening is occupied. If the sunroof is in the opened position and the sunroof opening is occupied, the system processes inputs, such as speed and/or steering of the vehicle and/or other aspects of the surroundings, to identify any potential threats. In order to prevent accidents and increase safety related to objects or occupants within the sunroof opening, the system may alert the driver or take control of vehicle operations.

For example, the system may include a camera disposed at a vehicle and viewing at least a sunroof region of the vehicle. A forward-sensing sensor may be disposed at the vehicle and sensing at least forward of the vehicle. An electronic control unit (ECU) includes electronic circuitry and associated software, with the electronic circuitry including at least one data processor for processing image data captured by the camera and transferred to the ECU and for processing sensor data captured by the forward-sensing sensor and transferred to the ECU. Responsive to (i) the vehicle moving and (ii) the sunroof being in the opened position, the vehicular sunroof system, via processing at the ECU of image data captured by the camera, is operable to determine presence of an object at the sunroof opening (e.g., a person or other object extending through the sunroof opening so as to be partially outside of the vehicle). With the vehicle moving and with the sunroof being in the opened position, and responsive to determination, via processing at the ECU of image data captured by the camera, of presence of the object at the sunroof opening, and based in part on processing at the ECU of sensor data captured by the forward-sensing sensor, the vehicular sunroof system at least one selected from the group consisting of (a) generates an alert and (b) controls at least one selected from the group consisting of steering of the vehicle and braking of the vehicle.

Optionally, a road condition (e.g., road curvature, road bumps, traffic, traffic lights, stop sign, etc.) ahead of the vehicle may be determined via processing at the ECU of sensor data captured by the forward-sensing sensor, and the vehicular sunroof system generates the alert and/or controls steering and/or braking of the vehicle based in part on the determined road condition. Optionally, a hazardous driving condition ahead of the vehicle may be determined via processing at the ECU of sensor data captured by the forward-sensing sensor, and the vehicular sunroof system generates the alert and/or controls steering and/or braking of the vehicle based in part on the determined hazardous driving condition. The hazardous driving condition may be determined based on at least one selected from the group consisting of (i) road curvature ahead of the vehicle, (ii) speed of the vehicle being greater than a threshold speed, (iii) traffic ahead of the equipped vehicle, such as a traffic jam or accident that may require the vehicle to stop or swerve, and (iv) an object (e.g., a bridge, a sign, a tree branch, etc.) ahead of the vehicle at a location where the object or person determined to be present at the sunroof opening may impact the object ahead of the vehicle.

The forward-sensing sensor may comprise one or more radar sensors of the vehicle or one or more lidar sensors of the vehicle or a forward-viewing camera of the vehicle, such as a forward-viewing camera disposed at an in-cabin side of the vehicle windshield and viewing forward of the vehicle through the windshield.

From the perspective of the driver, the operation of the system is similar to other active safety features already available in current vehicles. The driver enables the system with the push of a button or it can be automatically enabled upon an ignition of the vehicle turning from off to on. After the system is enabled, the driver may (depending on the particular application of the system) further make mode selections such as (a) alert only mode, and (b) alert and mitigate mode.

In the “alert only” mode, the system alerts the driver about the presence of an object or occupant in the sunroof opening either through visual alerts or warnings, audible alerts or warnings, haptic alerts or warnings (e.g., vibration of the driver seat or steering wheel of the vehicle), or a combination of any of these types of alerts or warnings. Based on the warnings and the severity of the present driving situation, after processing of the data at the ECU, the driver is expected to take the appropriate actions without any intervention from the vehicle (slow down, steer, halt, etc.). In the “alert and mitigate” mode, the vehicle takes appropriate actions (braking, steering, etc.) in addition to the alerts or warnings based on the received data by the ECU.

The vehicular sunroof system determines the sunroof occupancy state in addition to the sunroof opened/closed states. This information, together with other inputs such as vehicle speed, environmental conditions, and road conditions, identify any potential threats related to the sunroof opening occupancy.

The sunroof monitoring camera may comprise a driver monitoring camera that captures image data for a driver monitoring system of the vehicle. For example, the system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. provisional application Ser. No. 63/673,225, filed Jul. 19, 2024, and/or U.S. provisional application Ser. No. 63/641,574, filed May 2, 2024, and/or International Publication No. WO 2023/220222, which are all hereby incorporated herein by reference in their entireties.

For autonomous vehicles suitable for deployment with the system, an occupant of the vehicle may, under particular circumstances, be desired or required to take over operation/control of the vehicle and drive the vehicle so as to avoid potential hazard for as long as the autonomous system relinquishes such control or driving. Such an occupant of the vehicle thus becomes the driver of the autonomous vehicle. As used herein, the term “driver” refers to such an occupant, even when that occupant is not actually driving the vehicle, but is situated in the vehicle so as to be able to take over control and function as the driver of the vehicle when the vehicle control system hands over control to the occupant or driver or when the vehicle control system is not operating in an autonomous or semi-autonomous mode.

Typically, an autonomous vehicle would be equipped with a suite of sensors, including multiple machine vision cameras deployed at the front, sides and rear of the vehicle, multiple radar sensors deployed at the front, sides and rear of the vehicle, and/or multiple lidar sensors deployed at the front, sides and rear of the vehicle. Typically, such an autonomous vehicle will also have wireless two-way communication with other vehicles or infrastructure, such as via a car2car (V2V) or car2x communication system.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front radar sensor or forward-sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The ECU may be operable to process data for at least one driving assist system of the vehicle. For example, the ECU may be operable to process data (such as image data captured by a forward-viewing camera of the vehicle that is disposed at an in-cabin side of a windshield of the vehicle and that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular sunroof system, the vehicular sunroof system comprising:
a sensor disposed at a vehicle equipped with the vehicular sunroof system, the sensor sensing at least a sunroof disposed at a roof of the vehicle, wherein the sensor is operable to capture sensor data;
wherein the sunroof is movable between a closed position, where the sunroof closes a sunroof opening in the roof of the vehicle, and an opened position, where the sunroof is moved from the sunroof opening;
an electronic control unit (ECU);
wherein the ECU comprises electronic circuitry and associated software;
wherein the electronic circuitry of the ECU comprises at least one data processor for processing sensor data captured by the sensor and transferred to the ECU;
wherein, responsive to (i) the vehicle moving and (ii) the sunroof being in the opened position, the vehicular sunroof system, via processing at the ECU of sensor data captured by the sensor, is operable to determine presence of an object at the sunroof opening; and
wherein, with the vehicle moving and with the sunroof being in the opened position, and responsive to determination, via processing at the ECU of sensor data captured by the sensor, of presence of the object at the sunroof opening, the vehicular sunroof system at least one selected from the group consisting of (a) generates an alert and (b) controls at least one selected from the group consisting of steering of the vehicle and braking of the vehicle.

2. The vehicular sunroof system of claim 1, wherein the vehicular sunroof system at least one selected from the group consisting of (a) generates the alert and (b) controls steering or braking of the vehicle based in part on processing at the ECU of sensor data captured by a forward-sensing sensor disposed at the vehicle and sensing at least forward of the vehicle.

3. The vehicular sunroof system of claim 2, wherein the forward-sensing sensor comprises one selected from the group consisting of (i) a radar sensor, (ii) a lidar sensor and (iii) a camera.

4. The vehicular sunroof system of claim 1, wherein one selected from the group consisting of (i) the sensor comprises a radar sensor and the sensor data transferred to and processed at the ECU comprises radar data captured by the radar sensor and (ii) the sensor comprises a lidar sensor and the sensor data transferred to and processed at the ECU comprises lidar data captured by the lidar sensor.

5. The vehicular sunroof system of claim 1, wherein the sensor comprises a camera that views within an interior cabin of the vehicle, and wherein the sensor data transferred to and processed at the ECU comprises image data captured by the camera.

6. The vehicular sunroof system of claim 5, wherein the camera comprises a CMOS imaging array having at least one million photosensors arranged in rows and columns.

7. The vehicular sunroof system of claim 5, wherein the camera views a driver head region within the interior cabin of the vehicle, and wherein image data captured by the camera is processed at the ECU for a driver monitoring system of the vehicle.

8. The vehicular sunroof system of claim 1, wherein the vehicular sunroof system is inoperable when the sunroof is in the closed position.

9. The vehicular sunroof system of claim 1, wherein the vehicular sunroof system at least one selected from the group consisting of (a) generates the alert based in part on a road condition forward of the vehicle and (b) controls the at least one selected from steering of the vehicle and braking of the vehicle based in part on the road condition forward of the vehicle.

10. The vehicular sunroof system of claim 9, wherein the road condition is determined at least in part via processing at the ECU of sensor data captured by a forward-sensing sensor of the vehicle.

11. The vehicular sunroof system of claim 10, wherein the forward-sensing sensor of the vehicle comprises a forward-viewing camera disposed at an in-cabin side of a windshield of the vehicle and viewing forward of the vehicle through the windshield.

12. The vehicular sunroof system of claim 9, wherein the road condition is determined based at least in part on map data.

13. The vehicular sunroof system of claim 12, wherein the map data is fused with sensor data captured by a forward-sensing sensor of the vehicle and the fused data is processed at the ECU to determine the road condition.

14. The vehicular sunroof system of claim 1, wherein the vehicular sunroof system at least one selected from the group consisting of (a) generates the alert and (b) controls steering or braking of the vehicle based in part on vehicle operation data.

15. The vehicular sunroof system of claim 14, wherein the vehicle operation data includes speed of the vehicle.

16. The vehicular sunroof system of claim 14, wherein the vehicle operation data includes steering angle of the vehicle.

17. The vehicular sunroof system of claim 1, wherein the vehicular sunroof system generates the alert, and wherein the alert comprises a visual alert to a driver of the vehicle.

18. The vehicular sunroof system of claim 1, wherein the vehicular sunroof system generates the alert, and wherein the alert comprises an audible alert to a driver of the vehicle.

19. The vehicular sunroof system of claim 1, wherein, with the vehicle moving and with the sunroof being in the opened position, and responsive to determination, via processing at the ECU of sensor data captured by the sensor, the vehicular sunroof system controls the at least one selected from the group consisting of steering of the vehicle and braking of the vehicle based in part on a hazardous driving condition ahead of the vehicle.

20. The vehicular sunroof system of claim 19, wherein the hazardous driving condition is determined based on road curvature ahead of the vehicle.

21. The vehicular sunroof system of claim 19, wherein the hazardous driving condition is determined based on speed of the vehicle being greater than a threshold speed.

22. The vehicular sunroof system of claim 19, wherein the hazardous driving condition is determined based on traffic ahead of the vehicle.

23. The vehicular sunroof system of claim 19, wherein the hazardous driving condition is determined based on an object ahead of the vehicle that is determined to be at a location where the object determined to be present at the sunroof opening may impact the object ahead of the vehicle.

24. A vehicular sunroof system, the vehicular sunroof system comprising:
a camera disposed at a vehicle equipped with the vehicular sunroof system, the camera viewing at least a sunroof disposed at a roof of the vehicle, wherein the camera is operable to capture image data;
a forward-sensing sensor disposed at the vehicle and sensing at least forward of the vehicle, wherein the forward-sensing sensor is operable to capture sensor data;
wherein the sunroof is movable between a closed position, where the sunroof closes a sunroof opening in the roof of the vehicle, and an opened position, where the sunroof is moved from the sunroof opening;
an electronic control unit (ECU);
wherein the ECU comprises electronic circuitry and associated software;
wherein the electronic circuitry of the ECU comprises at least one data processor for processing image data captured by the camera and transferred to the ECU and for processing sensor data captured by the forward-sensing sensor and transferred to the ECU;
wherein, responsive to (i) the vehicle moving and (ii) the sunroof being in the opened position, the vehicular sunroof system, via processing at the ECU of image data captured by the camera, is operable to determine presence of an object at the sunroof opening; and
wherein, with the vehicle moving and with the sunroof being in the opened position, and responsive to determination, via processing at the ECU of image data captured by the camera, of presence of the object at the sunroof opening, and based in part on processing at the ECU of sensor data captured by the forward-sensing sensor, the vehicular sunroof system at least one selected from the group consisting of (a) generates an alert and (b) controls at least one selected from the group consisting of steering of the vehicle and braking of the vehicle.

25. The vehicular sunroof system of claim 24, wherein the forward-sensing sensor comprises at least one selected from the group consisting of (i) a radar sensor and (ii) a lidar sensor.

26. The vehicular sunroof system of claim 24, wherein the forward-sensing sensor of the vehicle comprises a forward-viewing camera disposed at an in-cabin side of a windshield of the vehicle and viewing forward of the vehicle through the windshield.

27. The vehicular sunroof system of claim 24, wherein a road condition ahead of the vehicle is determined via processing at the ECU of sensor data captured by the forward-sensing sensor, and wherein the vehicular sunroof system at least one selected from the group consisting of (a) generates the alert and (b) controls the at least one selected from the group consisting of steering of the vehicle and braking of the vehicle based in part on the determined road condition.

28. The vehicular sunroof system of claim 27, wherein the road condition is determined based in part on map data.

29. The vehicular sunroof system of claim 28, wherein the map data is fused with sensor data captured by the forward-sensing sensor of the vehicle and the fused data is processed at the ECU to determine the road condition.

30. The vehicular sunroof system of claim 24, wherein the vehicular sunroof system at least one selected from the group consisting of (a) generates the alert and (b) controls steering or braking of the vehicle based in part on vehicle operation data, and wherein the vehicle operation data includes at least one selected from the group consisting of (i) speed of the vehicle and (ii) steering angle of the vehicle.

31. The vehicular sunroof system of claim 24, wherein a hazardous driving condition ahead of the vehicle is determined via processing at the ECU of sensor data captured by the forward-sensing sensor, and wherein the vehicular sunroof system at least one selected from the group consisting of (a) generates the alert and (b) controls the at least one selected from the group consisting of steering of the vehicle and braking of the vehicle based in part on the determined hazardous driving condition.

32. The vehicular sunroof system of claim 31, wherein the hazardous driving condition is determined based on at least one selected from the group consisting of (i) road curvature ahead of the vehicle, (ii) speed of the vehicle being greater than a threshold speed, (iii) traffic ahead of the vehicle and (iv) an object ahead of the vehicle at a location where the object determined to be present at the sunroof opening may impact the object ahead of the vehicle.

33. A vehicular sunroof system, the vehicular sunroof system comprising:
a camera disposed at a vehicle equipped with the vehicular sunroof system, the camera viewing at least a sunroof disposed at a roof of the vehicle, wherein the camera is operable to capture image data;
wherein the sunroof is movable between a closed position, where the sunroof closes a sunroof opening in the roof of the vehicle, and an opened position, where the sunroof is moved from the sunroof opening;
an electronic control unit (ECU);
wherein the ECU comprises electronic circuitry and associated software;
wherein the electronic circuitry of the ECU comprises an image processor for processing image data captured by the camera and transferred to the ECU;
wherein the camera views a driver head region within an interior cabin of the vehicle, and wherein image data captured by the camera is processed at the ECU for a driver monitoring system of the vehicle;
wherein, responsive to (i) the vehicle moving and (ii) the sunroof being in the opened position, the vehicular sunroof system, via processing at the ECU of image data captured by the camera, is operable to determine presence of an object at the sunroof opening;
wherein, with the vehicle moving and with the sunroof being in the opened position, and responsive to determination, via processing at the ECU of image data captured by the camera, of presence of the object at the sunroof opening, the vehicular sunroof system at least one selected from the group consisting of (a) generates an alert and (b) controls at least one selected from the group consisting of steering of the vehicle and braking of the vehicle; and
wherein the vehicular sunroof system at least one selected from the group consisting of (a) generates the alert and (b) controls the at least one selected from the group consisting of steering of the vehicle and braking of the vehicle based in part on a road condition ahead of the vehicle.

34. The vehicular sunroof system of claim 33, wherein the road condition is determined at least in part via map data.

35. The vehicular sunroof system of claim 33, wherein the vehicular sunroof system at least one selected from the group consisting of (a) generates the alert and (b) controls the at least one selected from the group consisting of steering of the vehicle and braking of the vehicle based in part on a hazardous driving condition ahead of the vehicle.

36. The vehicular sunroof system of claim 35, wherein the hazardous driving condition is determined based on at least one selected from the group consisting of (i) road curvature ahead of the vehicle, (ii) speed of the vehicle being greater than a threshold speed, (iii) traffic ahead of the vehicle and (iv) an object ahead of the vehicle at a location where the object determined to be present at the sunroof opening may impact the object ahead of the vehicle.
